(19) United States
(12) Patent Application Publication
(10) Pub. No.: US 2014/0258308 A1
(43) Pub. Date: Sep. 11, 2014

(54) Objective Application Rating

(71) Applicant: MICROSOFT CORPORATION, Redmond, WA (US)

(72) Inventor: Bogdan Mihai Manolache, Issaquah, WA (US)

(73) Assignee: MICROSOFT CORPORATION, Redmond, WA (US)

(21) Appl. No.: 13/786,457

(22) Filed: Mar. 6, 2013

(51) Int. Cl. G06F 17/30

(52) U.S. Cl. CPC G06F 17/30283
USPC 707/748

(57) ABSTRACT

Example apparatus and methods concern objective ratings for an application. The application may have been downloaded to a plurality of devices from a server or other device. One example method includes acquiring objective data about the application and then computing an objective rating for the application from the objective data. The objective data will be collected in electronic form. A portion of the objective data may be collected by a member(s) of the plurality of devices when the application is run on the member(s). The objective rating may be determined on a device that downloaded the application, on a device from which the application was downloaded, in a cloud service, or in other locations. The objective rating may be provided as electronic data that can be displayed by a computer, tablet, smart phone, or other device capable of processing and displaying electronic data.

### BACKGROUND

The number of applications available to computers, tablets, smart phones, and other computer devices continues to grow at an impressive rate. With so many applications available, and with so many applications that overlap in scope or that do the same thing, a user may be overwhelmed with choices. It may be difficult for a user to decide between multiple applications that are available. Conventionally, a user may have turned to application ratings to help decide which application to download. However, conventional application ratings tend to be subjective.

A subjective user rating of an application may depend, for example, on a user's experience with the application. For example, a weather application that shows the weather in different places around the world may be over-rated or under-rated based on the user experience with the application. However, whether the user had a good experience may be influenced by subjective factors like how the user felt about the size of icons, whether certain features were offered (e.g., radar, temperature), how long the application took to load, or other items evaluated by individual taste.

While subjective ratings provide some value to a user, the subjective ratings may be based on tastes or needs. Since different users have different tastes and needs, a subjective rating from one user or group of users may not provide the type of information upon which another user or group of users may wish to make a decision. Additionally, subjective ratings may be subject to manipulation, where users give excessively high or low ratings that are unrelated to the actual quality of an application. Thus, users may seek information other than conventional subjective ratings.

### SUMMARY

This Summary is provided to introduce, in a simplified form, a selection of concepts that are further described below in the Detailed Description. This Summary is not intended to identify key features or essential features of the claimed subject matter, nor is it intended to be used to limit the scope of the claimed subject matter.

Example apparatus and methods determine an objective rating for an application. The objective rating may be based on objective facts including, for example, the number of times an application is downloaded, the number of times an application is launched, the number of times an application terminates abnormally (e.g., crashes), or other facts. In one embodiment, an objective rating may be a function of objective facts. For example, a first objective rating may be based on a comparison of the number of times an application is downloaded to the number of times the application is launched. This first objective rating provides information about whether an application that is downloaded is ever used and, if so, how frequently. An application for which there is only one launch per download may have a lower objective rating than an application for which there are hundreds of launches per download.

Example apparatus and methods may be configured to observe downloads, launches, crashes, and other events associated with an application on a mobile device, on a server, in a cloud service, or in a combination of these or other places. Example apparatus and methods may compute sophisticated objective rankings based on functions that relate objective data. For example, a second objective rating may consider the ratio of launches to crashes of an application. An application that crashes only once per hundred thousand launches may receive a higher objective rating while an application that crashes ten thousand times per hundred thousand launches may receive a lower objective rating. Example apparatus and methods may present a set of objective ratings to allow a user to make a decision based on one or more objective ratings. For example, a user may want the application that has the highest launch to download ratio and that has the highest launch to crash ratio. The objective ratings are not influenced by user experience or needs, the objective ratings are only influenced by actual objective usage data.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples, one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example objective rater.

FIG. 2 illustrates an example method associated with objective application rating.

FIG. 3 illustrates an example method associated with objective application rating.

FIG. 4 illustrates an example objective rater.

FIG. 5 illustrates an example apparatus configured to compute an objective application rating.

FIG. 6 illustrates an example apparatus configured to compute an objective application rating.

FIG. 7 illustrates an example cloud operating environment.

FIG. 8 is a system diagram depicting an exemplary mobile communication device configured to compute an objective application rating.

FIG. 9 illustrates an example client-side method associated with objective application rating.

### DETAILED DESCRIPTION

Example apparatus and methods concern producing an objective rating for an application. An objective rating is a rating computed from facts concerning an item. Objective data is observable data. For example, the number of times an application has been downloaded is objective data because the fact that an application has been downloaded can be observed. Objective data, being factually based, will be the same from multiple observers of the event or item being reported on. Objective data concerns items that can be counted and described. A subjective rating is a rating computed based on user's opinions. A subjective rating may be based on fact but is a user's interpretation of the fact.

Objective ratings may be used by a purchaser to determine which application, if any, to download or otherwise acquire. The objective rating may be computed from objective data including, for example, how many times the application has been downloaded, how many times a downloaded application has been launched, how many times the downloaded application terminated abnormally (e.g., crashed), or other objective data.

An application may have been downloaded to a plurality of devices from a server(s) or other device(s). One example method includes acquiring objective data about the application and then computing an objective rating for the application from the objective data. The objective data will be collected as electronic data. “Electronic data”, as used herein, refers to data that is processed by a circuit or processor (e.g., microprocessor) in a computer, computing device (e.g., smart phone, tablet), or elsewhere. Data that can be processed by a human mind or by paper and pencil is not “electronic data” as used herein. The data may be collected through channels including, but not limited to, a wireless network, a cable network, cellular data channels, and other channels.

A portion of the objective data may be collected by a member(s) of the plurality of devices when the application was run on the member(s). The objective rating may be determined in different locations. For example, the objective rating may be determined on a device that downloaded the application, on a device from which the application was downloaded, in a cloud service, or in other locations. The objective rating may be provided as electronic data that can be displayed by a computer, tablet, smart phone, or other device capable of processing and displaying electronic data. A user may consult the objective data to determine whether to download the application.

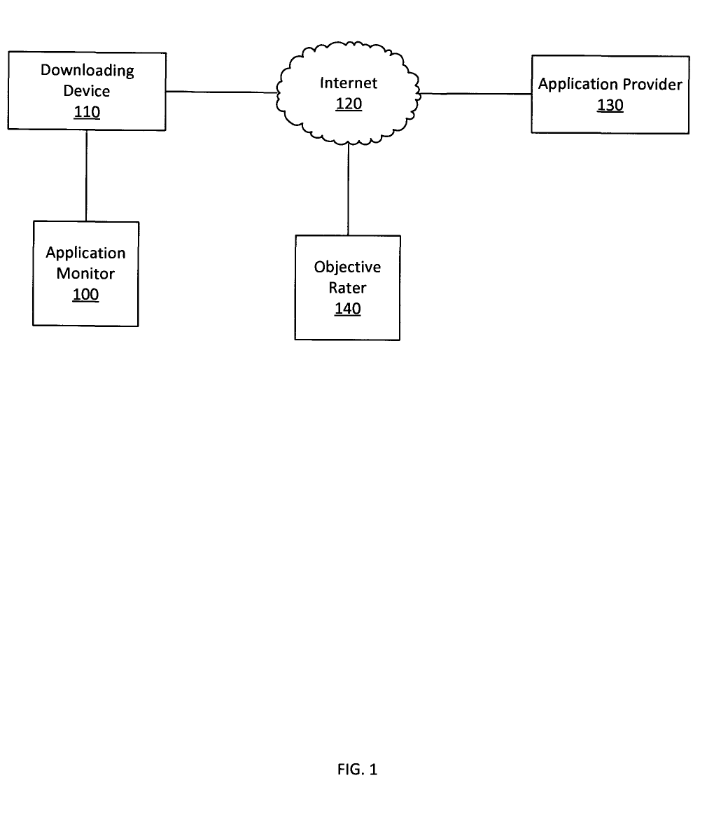

FIG. 1 illustrates an example objective rater 140. An application may reside on an application provider 130. The application provider 130 may be, for example, a server, a service, or other apparatus or process from which an application can be downloaded or otherwise acquired. A user of a downloading device 110 may download the application from the application provider 130. The downloading device 110 may be, for example, a computer, a tablet computer, a smart phone, a gaming console or portable device, or other device or process that can download applications. The downloading device 110 may download the application from the application provider 130 through, for example, the internet 120. The application may also be downloaded through other communication or delivery systems. An application monitor 100 may observe activity associated with the downloading device 110. For example, the application monitor 100 may observe which applications are downloaded, the number of times an application is run, the number of times the application crashes, how long the application is run for, and other observable objective items.

An objective rater 140 may acquire information from the application monitor 100, from the downloading device 110, from the application provider 130, or from other entities and then generate an objective rating about the application. Since different pieces of objective data may be available, the objective rater 140 may produce a number of objective ratings using a number of different functions. In one embodiment, a user may configure the objective rater 140 to acquire particular objective data and may even provide a function for computing a user-defined objective rating. The objective rater 140 may be implemented in hardware, in software, or in a combination of hardware and software.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and other terms. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

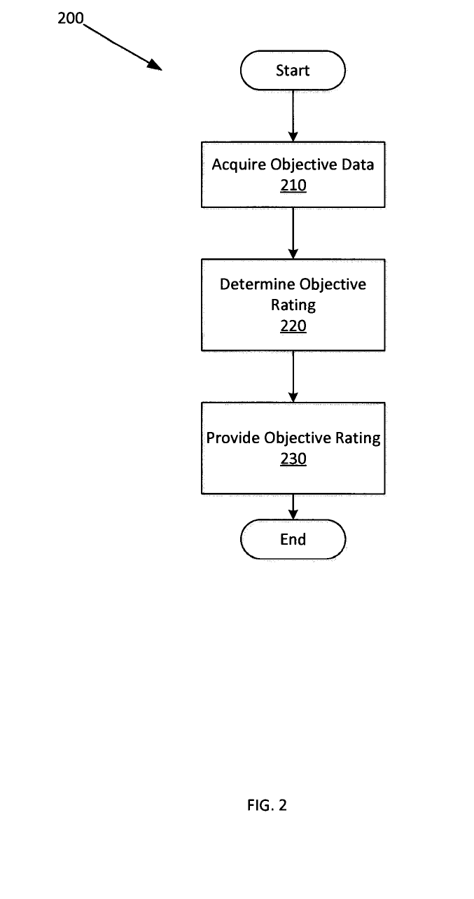

FIG. 2 illustrates an example method 200 associated with objective application rating. In different examples, method 200 may be performed on a single device, may be performed partially or completely in the cloud, may be performed on distributed co-operating devices, or may be performed other ways. In different examples, method 200 may be performed on devices including, but not limited to, a computer, a laptop computer, a tablet computer, a phone, and a smart phone.

Method 200 may include, at 210, acquiring objective data concerning an application downloaded by a plurality of devices. The devices may be computers, tablet computers, smart phones, or other devices. At least a portion of the objective data that is acquired may be electronic data that is collected by a member of the plurality of devices when the application is run by the member. For example, when the application is launched, information about the existence of the launch may be acquired. Additionally, other information (e.g., number of clicks, time of use) may be acquired. If the application terminates normally, that information may be acquired, and if the application terminates abnormally, that information may also be acquired. Different types and sets of observable objective data may be acquired. The objective data may include, but is not limited to, the number of times an application is downloaded, the number of times an application is launched, the number of times an application terminates normally, the number of times an application terminates abnormally, the number of user interactions with an application, the amount of time an application is active, the number of times an application is uninstalled, the amount of time between a download and uninstall, and the number of crashes between download and uninstall.

In different embodiments and in different configurations, the objective data may be acquired from different locations. For example, at least a portion of the objective data may be acquired from a monitor application running on a member of the plurality of devices. In this example, the portion of the objective data may be provided in a monitor application format (e.g., software quality management (SQM)). Data may be collected from a plurality of devices to which the application is downloaded. Thus, the objective rating may be based on aggregate data from multiple devices, not just data from a single device.

In another embodiment, at least a portion of the objective data is acquired from a device from which the application was downloaded. For example, an application server may provide information about the number of times an application is downloaded. The information may be pushed to an objective rater, may be pulled from the server by the objective rater, may be provided periodically, or in other ways.

Method 200 also includes, at 220, determining an objective rating for the application as a function of the objective data. In one embodiment, the objective data includes the number of times the application has been downloaded, the number of times the application has been launched, or the number of times the application has terminated abnormally.

Different functions may be used to produce different objective ratings. In one example, where a user may simply be interested in whether people who download an application ever use that application, the function may be A divided by B, where A is the number of times the application has been launched and B is the number of times the application has been downloaded. In another example, where a user is interested in a more sophisticated metric that examines how reliable the application is, the function may be (X−Y)/Z, where X is the number of times the application has been launched, Y is the number of times the application has terminated abnormally, and Z is the number of times the application has been downloaded. Other functions, including user-defined functions, may be employed. Additionally, the function may include normalizing, discretizing, or processing data in other ways.

In one embodiment, the objective data may be associated with particular periods of time. Thus, in one example, the objective data may be acquired for a defined period of time. In this example, the objective rating may be computed for the defined period of time as a function of the objective data acquired during the defined period of time.

Method 200 also includes, at 230, providing the objective rating as electronic data. The electronic data may be used to present the rating on a display, to control an automated process, or in other ways. Method 200 may be performed by different processes or different devices. Thus, method 200 may include determining the objective rating at 220 on the device from which the application was downloaded, on the device to which the application was downloaded, or on a device that neither provided the application for download nor downloaded the application. In one example, the objective data is acquired by a cloud service and the objective rating is computed by the cloud service. With the acquisition and calculating occurring on the cloud service, the objective rating may also be provided as electronic data by the cloud service. In one embodiment, the raw data from which an objective rating is determined may also be provided or displayed.

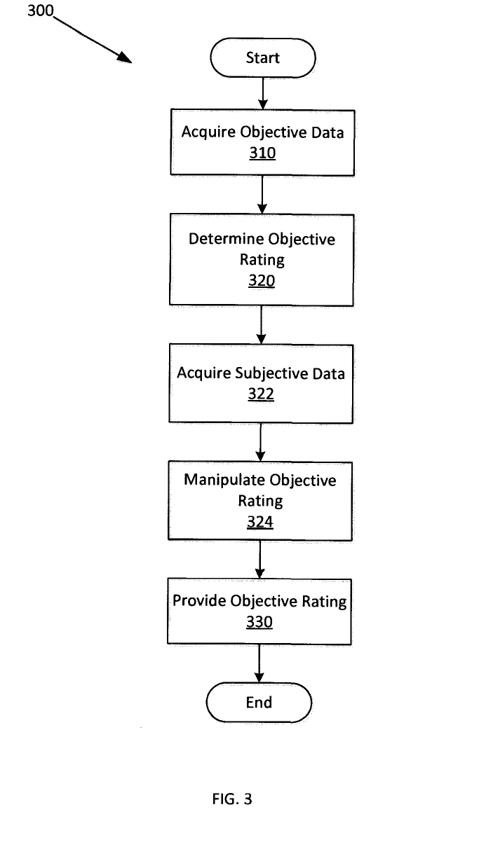

FIG. 3 illustrates an example method 300 associated with objective application rating. FIG. 3 shares some actions that are similar to actions described in connection with method 200 (FIG. 2). For example, method 300 includes acquiring objective data at 310, determining an objective rating at 320 and providing the objective rating at 330. However, method 300 also includes, at 322, acquiring subjective data concerning the application. In one embodiment, the subjective data may include, for example, user rankings. In one example, method 300 may acquire objective data about the subjective data. The objective data about the subjective data may be, for example, whether a subjective ranking exists, whether the subjective ranking is based on a threshold number of reviews, the standard deviation in the subjective ratings, and other objective information about a subjective ranking.

Method 300 may also include, at 324, updating the objective rating using the subjective data. Updating the objective rating may include, for example, increasing the objective rating, decreasing the objective rating, annotating the objective rating, or other actions. The updated objective rating may be referred to, for example, as a manipulated objective rating. In one example, when subjective data is used to update the objective rating, providing the objective rating at 330 may include providing the manipulated objective rating and an indication that the rating is not based purely on objective data.

While FIGS. 2 and 3 illustrates various actions occurring in serial, it is to be appreciated that various actions illustrated in FIGS. 2 and 3 could occur substantially in parallel. By way of illustration, a first process could acquire objective data, a second process could compute objective ratings, and a third process could provide the objective rating. While three processes are described, it is to be appreciated that a greater or lesser number of processes could be employed and that lightweight processes, regular processes, threads, and other approaches could be employed.

In one example, a method may be implemented as computer executable instructions. Thus, in one example, a computer-readable storage medium may store computer executable instructions that if executed by a machine (e.g., computer) cause the machine to perform methods described or claimed herein including methods 200 or 300. While executable instructions associated with the above methods are described as being stored on a computer-readable storage medium, it is to be appreciated that executable instructions associated with other example methods described or claimed herein may also be stored on a computer-readable storage medium. In different embodiments the example methods described herein may be triggered in different ways. In one embodiment, a method may be triggered manually by a user. In another example, a method may be triggered automatically.

In one embodiment, a computer-readable medium may store computer-executable instructions that when executed by a computer control the computer to perform a method for providing a cloud service. The method may include determining the number of times an application is downloaded in a period of time, determining the number of times the application is launched in the period of time, determining the number of times the application crashes in the period of time, and determining a purely objective rating for the application as a function of the number of times the application is downloaded in the period of time, the number of times the application is launched in the period of time, and the number of times the application crashes in the period of time. The number of times the application is launched and the number of times the application crashes may be determined from data aggregated from a plurality of devices to which the application is downloaded.

In one embodiment, the function is (A−B)/C, where A is the number of times the application is launched in the period of time, B is the number of times the application crashes in the period of time, and C is the number of times the application is downloaded in the period of time. In one embodiment, A is acquired by from a server from which the application is downloaded and B and C are acquired from devices that download the application.

In one embodiment, the method may include acquiring data identifying a subjective rating associated with the application, and manipulating the objective rating as a function of the subjective rating. The manipulated objective rating may be referred to as a manipulated objective rating.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an application specific integrated circuit (ASIC), a compact disk (CD), other optical medium, a random access memory (RAM), a read only memory (ROM), a memory chip or card, a memory stick, and other media from which a computer, a processor or other electronic device can read.

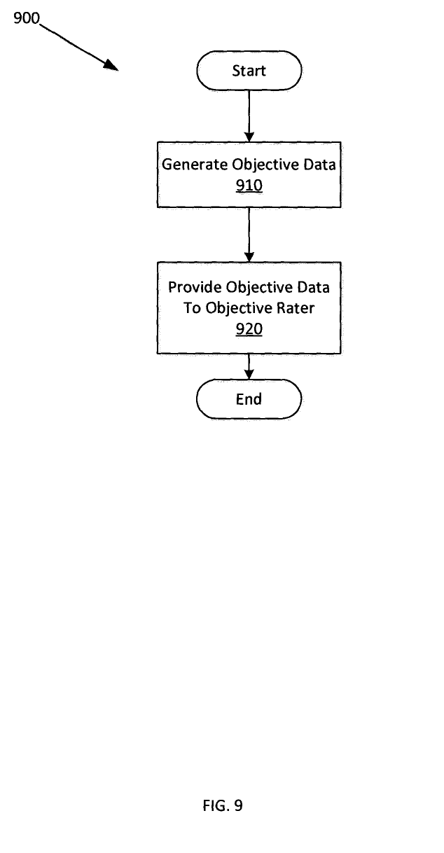

FIG. 9 illustrates an example client side method 900 associated with objective application rating. Method 900 includes, at 910, generating objective data on a mobile device (e.g., phone). The objective data may include, but is not limited to, the number of times an application is downloaded, the number of times an application is launched, the number of times an application terminates normally, the number of times an application terminates abnormally, the number of user interactions with an application, the amount of time an application is active, the number of times an application is uninstalled, the amount of time between a download and uninstall, and the number of crashes between download and uninstall.

Method 900 may also include, at 920, providing the objective data to an objective rater. Providing the objective data may include transmitting the data over channels including a wireless network, a cable network, cellular data channels, and other channels.

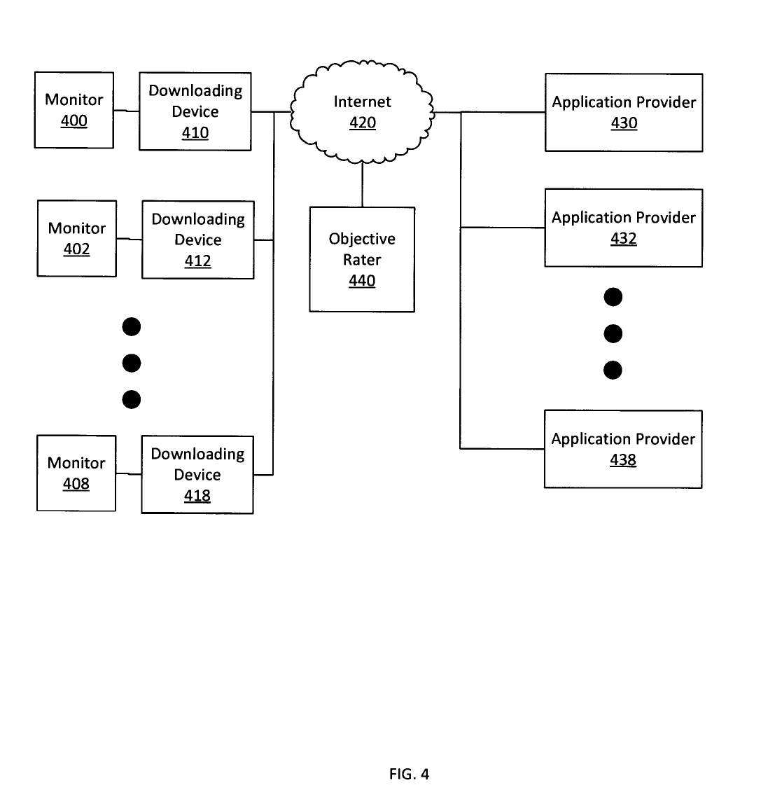

FIG. 4 illustrates an example objective rater 440. While FIG. 1 illustrated a single downloading device 110 and a single application provider 130, FIG. 4 illustrates a more complex environment where multiple different applications may be downloaded by multiple downloading devices (e.g., 410, 412, . . . 418) from multiple different application providers (e.g., 430, 432, . . . 438). The downloaded applications may be monitored by multiple different application monitors (e.g., 400, 402, . . . 408). The applications may flow from the providers to the destination devices through, for example, the internet 420. Other delivery mechanisms may be employed. Objective rater 440 may acquire objective information from the providers, the downloading devices, the monitors, or from other locations, and then process the acquired objective information into an objective rating(s).

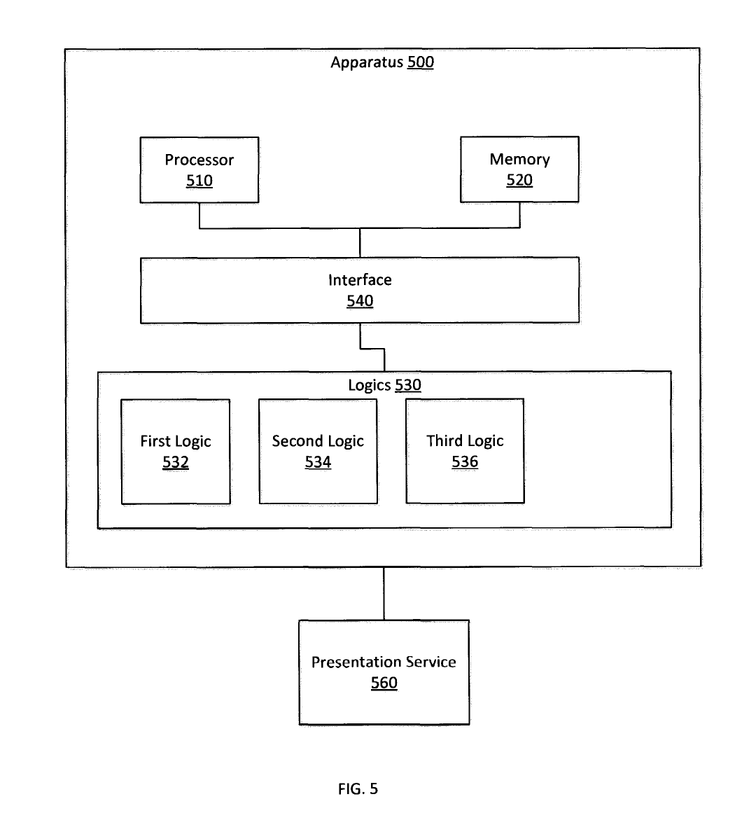

FIG. 5 illustrates an apparatus 500 that includes a processor 510, a memory 520, a set 530 of logics, and an interface 540 that connects the processor 510, the memory 520, and the set 530 of logics. The set 530 of logics may be configured to compute an objective rating for an application based on actual observed data associated with the application. Apparatus 500 may be, for example, a computer, a laptop computer, a tablet computer, a personal electronic device, a smart phone, or other device that can access and process data.

In one embodiment, the apparatus 500 may be a general purpose computer that has been transformed into a special purpose computer through the inclusion of the set 530 of logics. Apparatus 500 may interact with other apparatus, processes, and services through, for example, a computer network.

The set 530 of logics may include a first logic 532 that is configured to track objective statistics about the application acquired by the apparatus 500. In one embodiment, the first logic 532 may be configured to track statistics from a plurality of devices that have acquired the application, and to track statistics from a device that provided the application.

The set 530 of logics may also include a second logic 534 that is configured to compute the objective statistics-based rating for the application from the objective statistics. In one embodiment, the second logic 534 may be configured to compute the objective statistics-based rating as a function of the number of times the application has been acquired, the number of times the application has been launched, and the number of times the application has crashed. Different functions may be used to compute the rating from the objective data.

The set 530 of logics may also include a third logic 536 that is configured to provide the objective statistics-based rating. In one embodiment, the third logic 536 may be configured to provide the objective statistics-based rating to another apparatus that has acquired the application or to the device that provided the application. Providing the objective statistics-based rating may include, for example, storing values in memory 520, providing values to processor 510, transmitting values to a device from apparatus 500, displaying a rating on a display associated with apparatus 500, and other actions.

In one embodiment, the first logic 532 may be configured to track a set of user-defined objective statistics and the second logic 534 may be configured to compute the objective statistics-based rating using a user-defined function applied to the set of user-defined objective statistics.

In different embodiments, some processing may be performed on the apparatus 500 and some processing may be performed by an external service or apparatus. Thus, in one embodiment, apparatus 500 may also include a communication circuit that is configured to communicate with an external source to facilitate computing the objective rating on the service by providing at least a portion of the objective data from the apparatus 500 to the service or by receiving statistics from the service. In one embodiment, the third logic 536 may interact with a presentation service 560 to facilitate displaying data using different presentations for different devices.

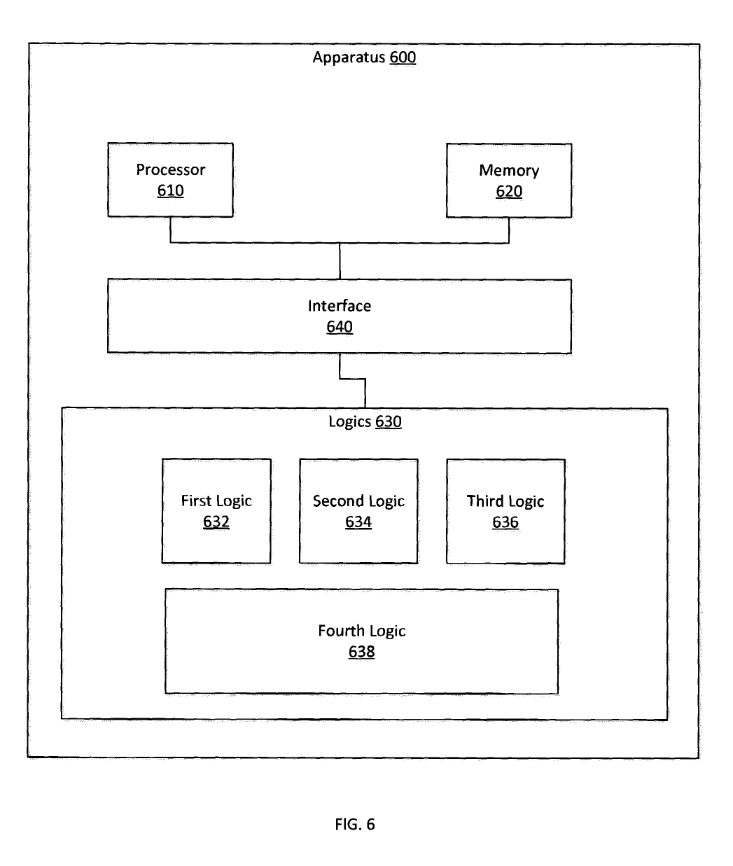

FIG. 6 illustrates an apparatus 600 that is similar to apparatus 500 (FIG. 5). For example, apparatus 600 includes a processor 610, a memory 620, a set of logics 630 (e.g., 632, 634, 636) that correspond to the set of logics 530 (FIG. 5) and an interface 640. Additionally, apparatus 600 may access the presentation service 560 (FIG. 5). However, apparatus 600 includes an additional fourth logic 638. The fourth logic 638 may be configured to acquire subjective data about the application and to selectively manipulate the objective statistics-based rating as a function of the subjective data. Manipulating the objective statistics-based rating may include, for example, changing the rating, annotating the rating, voting the rating up, voting the rating down, or other actions. Voting up a rating may involve providing an indication that the rating should be increased without actually changing the rating directly. Similarly, voting down a rating may involve providing an indication that the rating should be decreased without actually changing the rating.

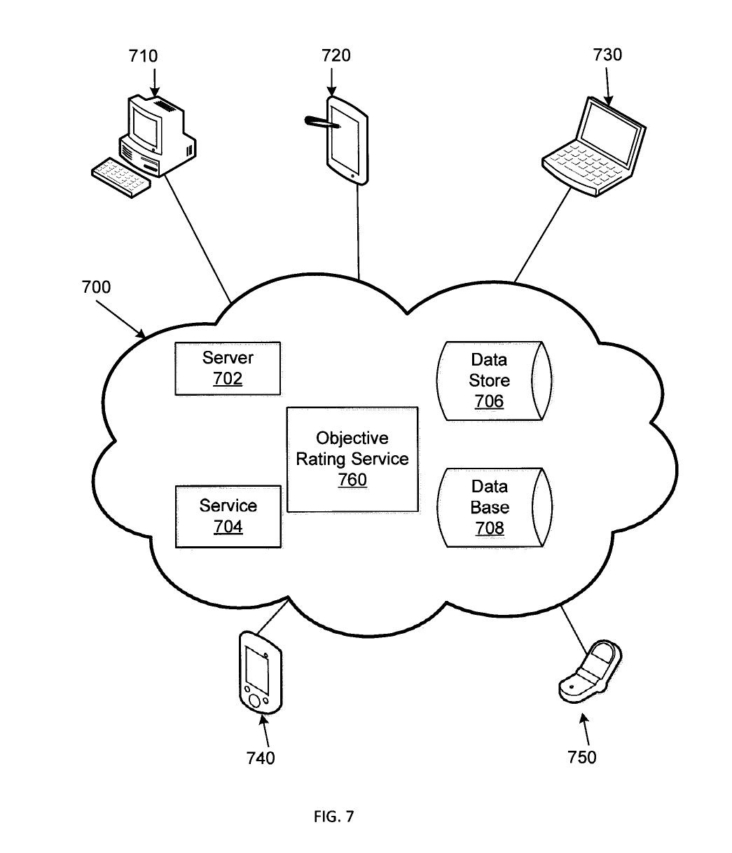

FIG. 7 illustrates an example cloud operating environment 700. A cloud operating environment 700 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 7 illustrates an example objective rating service 760 residing in the cloud. The objective rating service 760 may rely on a server 702 or service 704 to perform processing and may rely on a data store 706 or database 708 to store data. While a single server 702, a single service 704, a single data store 706, and a single database 708 are illustrated, multiple instances of servers, services, data stores, and databases may reside in the cloud and may, therefore, be used by the objective rating service 760.

FIG. 7 illustrates various devices accessing the objective rating service 760 in the cloud. The devices include a computer 710, a tablet 720, a laptop computer 730, a personal digital assistant 740, and a mobile device (e.g., cellular phone, satellite phone) 750. The objective rating service 760 may produce an observation based objective rating about an application. The observation based objective rating may be electronic data suitable for processing or display by the devices (e.g., computer 710, tablet 720, . . . mobile device 750). The observation based objective rating may include one or more ratings from which a potential purchaser or other potential downloader may base a decision. The observation based objective rating may be based on data about an application downloaded by or used by the devices (e.g., computer 710, tablet 720, . . . mobile device 750). In one example, the devices (e.g., computer 710, tablet 720, . . . mobile device 750) may push data to service 760 while in another example the service 760 may pull data from the devices (e.g., computer 710, tablet 720, . . . mobile device 750).

It is possible that different users at different locations using different devices may access the objective rating service 760 through different networks or interfaces. In one example, the objective rating service 760 may be accessed by a mobile device 750. In another example, portions of objective rating service 760 may reside on a mobile device 750.

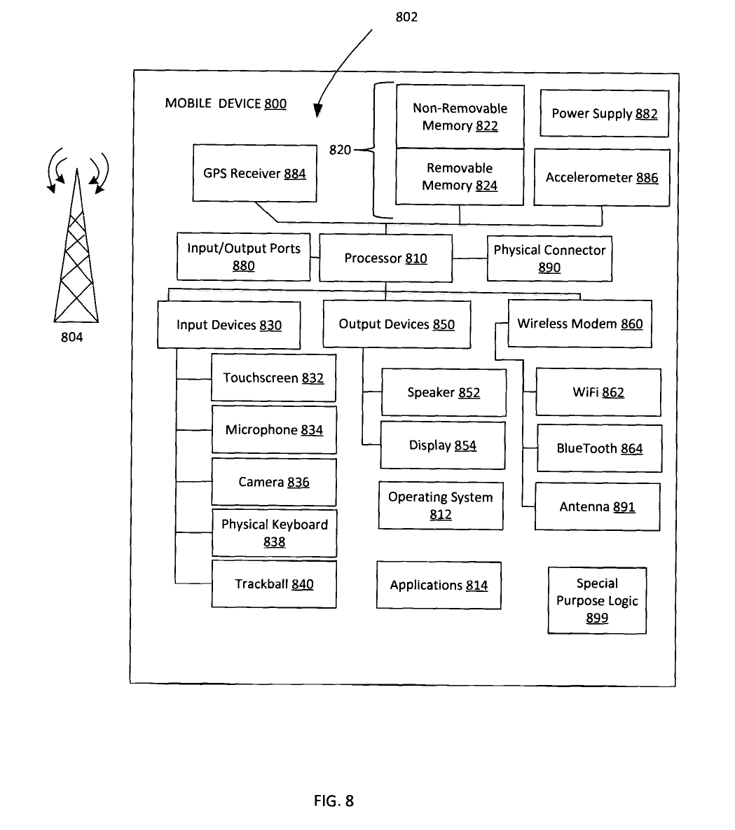

FIG. 8 is a system diagram depicting an exemplary mobile device 800 that includes a variety of optional hardware and software components, shown generally at 802. Components 802 in the mobile device 800 can communicate with other components, although not all connections are shown for ease of illustration. The mobile device 800 can be a variety of computing devices (e.g., cell phone, smartphone, handheld computer, Personal Digital Assistant (PDA), etc.) and can allow wireless two-way communications with one or more mobile communications networks 804, such as a cellular or satellite networks.

Mobile device 800 can include a controller or processor 810 (e.g., signal processor, microprocessor, ASIC, or other control and processing logic circuitry) for performing tasks including signal coding, data processing, input/output processing, power control, or other functions. An operating system 812 can control the allocation and usage of the components 802 and support application programs 814. The application programs 814 can include mobile computing applications (e.g., email applications, calendars, contact managers, web browsers, messaging applications), or other computing applications.

Mobile device 800 can include memory 820. Memory 820 can include non-removable memory 822 or removable memory 824. The non-removable memory 822 can include RAM, ROM, flash memory, a hard disk, or other memory storage technologies. The removable memory 824 can include flash memory or a Subscriber Identity Module (SIM) card, which is well known in GSM communication systems, or other memory storage technologies, such as “smart cards.” The memory 820 can be used for storing data or code for running the operating system 812 and the applications 814. Example data can include web pages, text, images, sound files, video data, or other data sets to be sent to or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 800 can support one or more input devices 830 including, but not limited to, a touchscreen 832, a microphone 834, a camera 836, a physical keyboard 838, or trackball 840. The mobile device 800 may also support output devices 850 including, but not limited to, a speaker 852 and a display 854. Other possible output devices (not shown) can include piezoelectric or other haptic output devices. Some devices can serve more than one input/output function. For example, touchscreen 832 and display 854 can be combined in a single input/output device. The input devices 830 can include a Natural User Interface (NUI). An NUI is an interface technology that enables a user to interact with a device in a “natural” manner, free from artificial constraints imposed by input devices such as mice, keyboards, remote controls, and others. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can comprise speech-recognition software as part of a voice user interface that allows a user to operate the device 800 via voice commands. Further, the device 800 can include input devices and software that allow for user interaction via a user's spatial gestures, such as detecting and interpreting gestures to provide input to a gaming application.

A wireless modem 860 can be coupled to an antenna 891. In some examples, RF filters are used and the processor 810 need not select an antenna configuration for a selected frequency band. The wireless modem 860 can support two-way communications between the processor 810 and external devices. The modem 860 is shown generically and can include a cellular modem for communicating with the mobile communication network 804 and/or other radio-based modems (e.g., Bluetooth 864 or Wi-Fi 862). The wireless modem 860 may be configured for communication with one or more cellular networks, such as a GSM network for data and voice communications within a single cellular network, between cellular networks, or between the mobile device and a public switched telephone network (PSTN).

The mobile device 800 may include at least one input/output port 880, a power supply 882, a satellite navigation system receiver 884, such as a Global Positioning System (GPS) receiver, an accelerometer 886, or a physical connector 890, which can be a USB port, IEEE 1394 (FireWire) port, RS-232 port, or other port. The illustrated components 802 are not required or all-inclusive, as other components can be deleted or added.

Mobile device 800 may include a special purpose logic 899 that is configured to provide a functionality for the mobile device 800. For example, logic 899 may provide a client for interacting with a service (e.g., service 760, FIG. 7), for collecting objective data, or for providing objective observed data (e.g., downloads, launches, crashes, clicks, time of use, uninstalls) to the service. Mobile device 800 may download an application, then run a monitoring application that provides objective data about the application to the service.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

1. A method, comprising:
acquiring objective data concerning an application downloaded by a plurality of devices, where at least a portion of the objective data comprises electronic data collected by a member of the plurality of devices when the application was run by the member;
determining an objective rating for the application as a function of the objective data; and
providing the objective rating as electronic data.

2. The method of claim 1, where the objective data includes the number of times the application has been downloaded, the number of times the application has been launched, or the number of times the application has terminated abnormally.

3. The method of claim 2, where the function is X divided by Y, where X is the number of times the application has been launched and Y is the number of times the application has been downloaded.

4. The method of claim 2, where the function is (A−B)/C, where A is the number of times the application has been launched, B is the number of times the application has terminated abnormally, and C is the number of times the application has been downloaded.

5. The method of claim 1, where the objective data includes the length of time the application was active per launch, the number of user interactions with the application per launch, the number of times the application has been uninstalled, the amount of time between a download and an uninstall, or the number of crashes between a download and an uninstall.

6. The method of claim 1, where at least a first portion of the objective data is acquired from a monitor application running on a member of the plurality of devices and where the first portion of the objective data is provided in a monitor application format.

7. The method of claim 6, where at least a second portion of the objective data is acquired from a device from which the application was downloaded.

8. The method of claim 1, comprising:
acquiring the objective data for a defined period of time, and
determining the objective rating for the defined period of time as a function of the objective data acquired during the defined period of time.

9. The method of claim 1, comprising:
determining the objective rating on the device from which the application was downloaded,
determining the objective rating on a device to which the application was downloaded, or
determining the objective rating on a device that neither provided the application for download nor downloaded the application.

10. The method of claim 1, where acquiring the objective data is performed by a cloud service, where determining the objective rating is performed by the cloud service, and where providing the objective rating as electronic data is performed by the cloud service.

11. The method of claim 1, comprising:
acquiring subjective data concerning the application, and
updating the objective rating using the subjective data.

12. A computer-readable storage medium storing computer-executable instructions that when executed by a computer control the computer to perform a method for providing a cloud service, the method comprising:
determining the number of times an application is downloaded in a period of time;
determining the number of times the application is launched in the period of time;
determining the number of times the application crashes in the period of time; and
determining a purely objective rating for the application as a function of the number of times the application is downloaded in the period of time, the number of times the application is launched in the period of time, and the number of times the application crashes in the period of time,
where the number of times the application is launched in the period of time and the number of times the application crashes in the period of time are determined from data aggregated from a plurality of devices to which the application is downloaded.

13. The computer-readable storage medium of claim 12, where the function is (A−B)/C, where A is the number of times the application is launched in the period of time, B is the number of times the application crashes in the period of time, and C is the number of times the application is downloaded in the period of time.

14. The computer-readable storage medium of claim 13, where A is acquired from a server from which the application is downloaded and where B and C are acquired from devices that download the application.

15. The computer-readable storage medium of claim 14, wherein the method further comprises:
acquiring data identifying a subjective rating associated with the application, and
manipulating the objective rating as a function of the subjective rating to produce a manipulated objective rating.

16. An apparatus, comprising:
a processor;
a memory configured to store objective statistics about an application acquired by the apparatus;
a set of logics configured to determine an objective statistics-based rating for the application; and
an interface to connect the processor, the memory, and the set of logics;
the set of logics comprising:
a first logic configured to track objective statistics about the application acquired by the apparatus;
a second logic configured to compute the objective statistics-based rating for the application from the objective statistics; and
a third logic configured to provide the objective statistics-based rating.

17. The apparatus of claim 16, the first logic being configured:
to track statistics from a plurality of devices that have acquired the application, and
to track statistics from a device that provided the application.

18. The apparatus of claim 17, the second logic being configured to compute the objective statistics-based rating as a function of the number of times the application has been acquired, the number of times the application has been launched, and the number of times the application has crashed.

19. The apparatus of claim 16,
the first logic being configured to track a set of user-defined objective statistics, and
the second logic being configured to compute the objective statistics-based rating using a user-defined function applied to the set of user-defined objective statistics.

20. The apparatus of claim 16, comprising a fourth logic configured to acquire subjective data about the application and to selectively manipulate the objective statistics-based rating as a function of the subjective data.
